(19) United States
(12) Patent Application Publication
(10) Pub. No.: US 2026/0158558 A1
(43) Pub. Date: Jun. 11, 2026

(54) TEMPERATURE MEASUREMENT AND CONTROL FOR LIQUID METAL JETTING THREE-DIMENSIONAL PRINTING

(71) Applicant: Additive Technologies, LLC dba ADDiTEC, Palm City, FL (US)

(72) Inventors: Chu-heng Liu, Penfield, NY (US); Paul J. McConville, Durham, NC (US); Brian Matthews, Palm Beach Gardens, FL (US); Sriram Manoharan, Port St. Lucie, FL (US)

(73) Assignee: Additive Technologies, LLC dba ADDiTEC, Palm City, FL (US)

(21) Appl. No.: 19/183,306

(22) Filed: Apr. 18, 2025

Related U.S. Application Data
(63) Continuation-in-part of application No. 18/659,174, filed on May 9, 2024.

(51) Int. Cl. B22F 10/362; B22F 10/22; B22F 10/85; B22F 12/13; B33Y 30/00; B33Y 40/10; B33Y 50/02

(52) U.S. Cl. CPC B22F 10/362; B22F 10/22; B22F 10/85; B22F 12/13; B33Y 30/00; B33Y 40/10; B33Y 50/02

(57) ABSTRACT

A method for controlling temperature in a liquid metal three-dimensional (3D) printing system is disclosed, including ejecting a liquid metal drop from a nozzle onto a deposition location to form a portion of a three-dimensional object. The method also includes measuring a temperature at a measurement spot location offset from the deposition location, and comparing the measured temperature with a set point temperature in the deposition location, adjusting a cooling rate of the liquid metal drop. The deposition follows a toolpath to form the portion of the three-dimensional object. The measurement spot location can be located within the toolpath or outside of a toolpath of the three-dimensional object being formed. An additive manufacturing device configured to perform the method includes a printhead that includes a nozzle having an inner cavity, where the nozzle is configured for ejecting droplets of liquid metal drops to form a three-dimensional object.

### REFERENCE TO RELATED APPLICATIONS

This application is a Continuation-in-Part of U.S. application Ser. No. 18/659,174, filed on May 9, 2024. The Ser. No. 18/659,174 application is hereby incorporated by reference in its entirety.

### TECHNICAL FIELD

The present teachings relate generally to three-dimensional printing with metal and, more particularly, to temperature measurement and control in the operation of three-dimensional printing with metal.

### BACKGROUND

Three-dimensional printers used for fabricating with metal can include drop-on-demand printers which eject a small drop of liquid aluminum alloy when a firing pulse is applied. Using this technology, a three-dimensional (3D) part can be created from aluminum-based alloys and other metallic materials by ejecting a series of drops which bond together to form a continuous part upon cooling.

To build a part of high quality and strength, liquid metal drops need to bond well with previously deposited drops and layers. Temperature and heat control is very critical to the formation of these high-quality part builds. To achieve adequate bonding for higher melting point metals, such as copper, steel and others, a focused preheating operation can be utilized. Control of this proposed focused heating can be useful for improved process control and monitoring.

The temperature of an ejected liquid metal drop undergoes a very rapid change, on the order of as high as hundreds of degrees per millisecond, immediately following deposition. The temperature measurement timing and location are very important for process control.

Therefore, it is desirable to develop a temperature measurement and control system and method that measures the temperature dynamics of a metal jetting process during part formation.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A method for controlling temperature in a liquid metal three-dimensional (3D) printing system is disclosed, the method including ejecting a liquid metal drop from a nozzle onto a deposition location to form a portion of a three-dimensional object. The method also includes measuring a temperature at a measurement spot location offset from the deposition location, comparing the measured temperature with a set point temperature in the deposition location, adjusting a cooling rate of the liquid metal drop, and where the deposition follows a toolpath to form the portion of the three-dimensional object. Implementations of the method for controlling temperature in a liquid metal three-dimensional (3D) printing system where the measurement spot location is located within the toolpath of the three-dimensional object being formed. The measurement spot location can be located outside of a toolpath of the three-dimensional object being formed. The method for controlling temperature in a liquid metal three-dimensional (3D) printing system may include measuring the temperature before the liquid metal drop is ejected. The method for controlling temperature in a liquid metal three-dimensional (3D) printing system may include measuring the temperature after the liquid metal drop is ejected. The method for controlling temperature in a liquid metal three-dimensional (3D) printing system may include estimating a quantity of laser power needed to raise a temperature on or near the deposition location based on a difference of the measurement temperature and the set point temperature, and heating with a laser to raise the temperature on or near the deposition location. The method for controlling temperature in a liquid metal three-dimensional (3D) printing system may include adjusting the laser power to maintain a setpoint temperature in the deposition location. The temperature measurements use noncontact point sensors that move in-sync with the nozzle. The method for controlling temperature in a liquid metal three-dimensional (3D) printing system may include adjusting the measurement spot location in response to changes in a direction of the toolpath. Multiple point sensors can be used to measure temperature. A time interval between a liquid metal drop deposition and the temperature measurement is from about 0.5 ms to about 50 ms and a measurement spot location is around 0.5 to about 10 mm from the deposition location. Implementations of the techniques described herein can include hardware, a method or process, system control logic, or computer software on a computer-accessible medium to control or operate one or more of the described steps.

A method for controlling temperature in a liquid metal three-dimensional (3D) printing system is disclosed. The method includes ejecting a liquid metal drop from a nozzle onto a deposition location to form a portion of a three-dimensional object, measuring a temperature at a measurement spot location offset from the deposition location, comparing the measured temperature with a set point temperature in the deposition location, estimating a quantity of laser power needed to raise a temperature on or near the deposition location based on a difference of the measurement temperature and the set point temperature. The method also includes heating with a laser to raise the temperature on or near the deposition location. The method also includes adjusting the laser power to maintain a setpoint temperature in the deposition location, and where the deposition follows a toolpath to form the portion of the three-dimensional object. Implementations of the method for controlling temperature in a liquid metal three-dimensional (3D) printing system include where the measurement spot location is located within the toolpath of the three-dimensional object being formed or where the measurement spot location is located outside of a toolpath of the three-dimensional object being formed. A time interval between a liquid metal drop deposition and the temperature measurement is from about 0.5 ms to about 50 ms and a measurement spot location is around 0.5 to about 10 mm from the deposition location.

An additive manufacturing device is disclosed, including a printhead that includes a nozzle having an inner cavity, where the nozzle is configured for ejecting droplets of liquid metal drops to form a three-dimensional object. The device also includes at least one temperature sensor configured to measure the temperature of the liquid metal drop before and after deposition. The device includes a controller in communication with the temperature sensor for estimating laser power based on a pre-drop measurement temperature and adjusting the laser power based on a post-drop measurement temperature, and operates where multiple point sensors are used to measure different locations and angles. Implementations of the additive manufacturing device include where a distance between a drop deposition and the measurement is from about 0.5 to about 10 mm and the temperature measurements are taken within from about 0.5 ms to about 50 ms of deposition of the drop.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 depicts a schematic cross-sectional view of a single liquid metal ejector jet of a 3D printer (e.g., a MHD printer and/or multi-jet printer), in accordance with the present disclosure.

FIGS. 2A and 2B are temperature plots depicting a temperature vs. time curve for a laser direct energy deposition system and a liquid metal jetting system, respectively, in accordance with the present disclosure.

FIG. 3 is a measurement schematic for a liquid metal jetting system, in accordance with the present disclosure.

FIG. 4 is a measurement schematic for a liquid metal jetting system, in accordance with the present disclosure.

FIG. 5 is a measurement schematic for a liquid metal jetting system, in accordance with the present disclosure.

FIG. 6 is a plot depicting the evolution of an ideal spot as it goes through the temperature control method, in accordance with the present disclosure.

FIG. 7 is a measurement schematic for a liquid metal jetting system, in accordance with the present disclosure.

FIG. 8 is a measurement schematic for a liquid metal jetting system, in accordance with the present disclosure.

FIG. 9 is a measurement schematic for a liquid metal jetting system, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

Temperature measurements before and after droplet deposition in time can be a useful aspect of process control for printers or additive manufacturing devices using drop-on-demand technology or an additive manufacturing process to eject small drops of liquid metals, such as aluminum alloys, when a firing pulse is applied. These temperature measurements can provide valuable information about the cooling and co-melting processes that occur during the deposition of each drop, allowing for real-time adjustments to be made to laser power assisted heating in order to achieve optimal part quality and strength.

To accurately measure these temperatures, the present disclosure provides systems and methods for taking measurements before and after droplet deposition within a time window of 0.5 to 50 milliseconds. These temperature measurements can be taken at locations ahead, behind, or alongside the droplet deposition spot along the toolpath, with a distance between the drop deposition and measurement of about 0.5 to about 10 millimeters. The use of multiple point sensors can further be employed to cover different directions and angles, providing more accurate temperature measurements across the entire print area.

The pre-droplet temperature measurement can be used to estimate the power required for spot pre-heating, for example with a focused laser, while the post-droplet measurement can serve to confirm the process and allow for adjustments to be made to the laser power if needed. By using a feedback loop with post-deposition transient temperature as the sensor and focused pre-heat as the actuator, real-time process control can be achieved, resulting in better part quality and strength due to controlled temperature during part formation.

The specific time interval between droplet deposition and temperature measurements may need to be adjusted based on the printing process, with the measurement locations determined by the printhead movement and desired measurement distance. The point temperature sensors used for measuring temperatures can be internally attached to the printhead assembly or externally attached while moving in synchronicity with the motion of the printhead assembly, ensuring accurate and consistent measurements as the printhead moves. A time interval between a liquid metal drop deposition and the temperature measurement can be from about 0.5 ms to about 50 ms, or from about 5 ms to about 500 ms. The offset distance between the drop landing spot and the temperature sensor measurement spot need not be fixed but can be adjusted based on the specific printing process, with software algorithms controlling the movement of the sensor based on the toolpath direction. The steering of measurement spots with respect to the toolpath direction allows for more accurate temperature measurements at different angles and directions, providing better coverage and control over the printing process. The measurement spot location between the deposition spot and a measurement spot can be from around 0.5 to about 10 mm or from about 5 mm to about 50 mm.

Due to space or temperature constraints on liquid metal jet processing and architecture, the desired measurements can only occur at certain positions in a part build toolpath, which can be implemented using a single sensor and used in measurements for all layers of a build structure. Alternatively, adjusting the offset position or rotation of the measurement spot with respect to the drop deposition spot allows for more flexibility in changing the toolpath direction, and further, having heat distribution or heating spot location being based on toolpath direction changes, or toolpath direction in general. Multiple scanning devices can also be used to measure temperature, with selected sensors being employed for each toolpath angle. The transient temperature measurements are functional for process control of focused pre-heating and thermal controls down to every droplet. An enabler of the system and methods of the present disclosure includes the small offset distance between the drop landing spot and the temperature sensor measurement spot. This allows for more meaningful, informative temperature readings as compared to when the measurement spots are directly above or at the droplet deposition spot. The minimum offset distance required for meaningful or useful measurements can depend on the specific printing condition and the specific sensors used and their accuracy requirements.

The use of point temperature sensors, used as temperature measurement devices, that move in-sync with the printhead is also disclosed herein. These sensors provide accurate and consistent temperature measurements during the printing process, as they allow for real-time monitoring of the droplet cooling and co-melting/bonding with previous drops or layers. The sensors can be positioned at a small offset distance from the drop landing spot, ensuring that they capture the transient temperature changes during the cooling and co-melting process. By measuring temperatures before and after droplet deposition in time and at locations ahead, behind, and/or near the droplet deposition spot, following the toolpath, these sensors provide useful information for process control and adjustment of the laser power (focused spot heating power) if needed.

The incorporation of a feedback loop with post-deposition transient temperature as the sensor and focused pre-heat as the actuator is another functional aspect of the present disclosure. By adjusting the laser power based on the post-deposition transient temperature measurements, real-time process control and optimization of the cooling rate can be achieved, resulting in better part quality and strength. This approach enables precise temperature controls down to every droplet, making it possible to print with a wide range of materials, including high melting point metals such as copper or steel.

The specific distance between a drop landing spot and the temperature sensor measurement spot can be adjusted based on the specific printing process and the desired measurement accuracy. The minimum offset distance required for accurate measurements will depend on the specific nature of the droplet cooling process and printing process. For example, a small droplet will cool down faster than a larger droplet and therefore requires a small offset. As another example, a faster printing speed will require a larger offset for similar time delays as compared to a slower printing speed. In general, it is desirable to measure the temperature at a location such that the droplet temperature has dropped significantly from its initial molten state but yet has not approached the asymptote of a steady state temperature. In examples, it may be helpful to ensure that the sensors are positioned correctly and calibrated properly to minimize any potential errors in measurement.

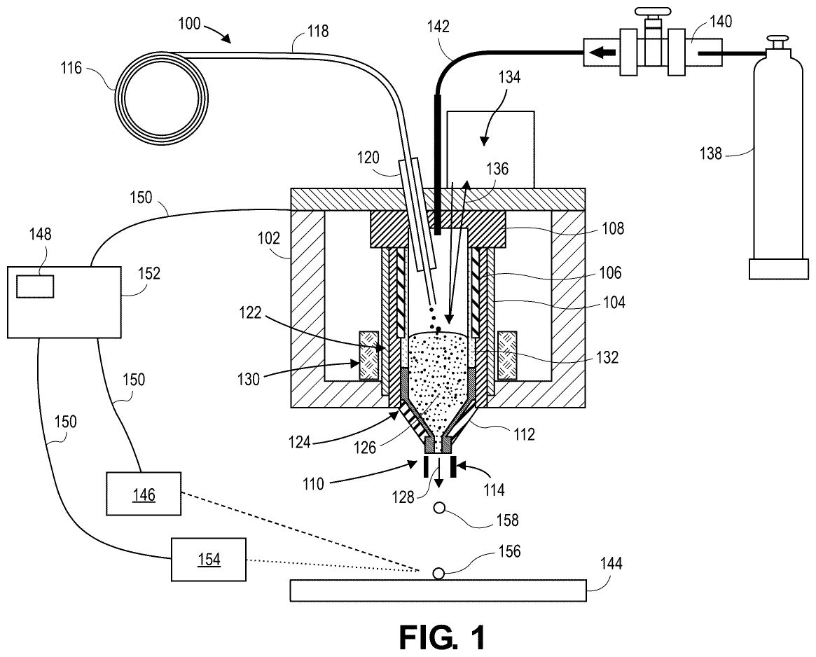

FIG. 1 depicts a schematic cross-sectional view of a single liquid metal ejector jet of a 3D printer (e.g., a MHD printer and/or multi-jet printer), in accordance with the present disclosure. FIG. 1 shows a portion of a type of drop-on-demand (DOD) or three-dimensional (3D) printer 100. The 3D printer, also referred to as an additive manufacturing system, or liquid ejector jet system 100 may include an ejector (also referred to as a body or pump chamber, or a “one-piece” pump) 104 within an outer ejector housing 102, also referred to as a lower block. The ejector 104 can be defined as an inner volume 132 (also referred to as an internal cavity or an inner cavity). The ejector 104 can be defined as a structure that can be selectively activated in such a manner as to cause a build material, print material to be ejected from a nozzle 110 of the ejector. The nozzle 110 can be defined as a physical structure of the ejector from which a build material or print material takes flight. A printing material 126 may be introduced into the inner volume 132 of the ejector 104. The printing material 126 may be or include a metal, a polymer, or the like. It should be noted that alternate jetting technology aside from MHD as described herein may be necessary depending on the nature and properties of the print material used in examples of the present disclosure. For example, the printing material 126 may be or include aluminum or aluminum alloy, introduced via a printing material supply 116 or spool of a printing material wire feed 118, in this case, an aluminum wire. It should be noted that other metals or alloys capable of being used in such a metal jetting system can be used. For example, copper, nickel, silver, steel, titanium, and combinations or alloys thereof. The liquid ejector jet system 100 further includes a first inlet 120 within a pump cap or top cover portion 108 of the ejector 104 whereby the printing material wire feed 118 is introduced into the inner volume 132 of the ejector 104. The ejector 104 further defines a nozzle 110, an upper pump 122 area and a lower pump 124 area. One or more heating elements 112 are distributed around the pump chamber 104 to provide an elevated temperature source and maintain the printing material 126 in a molten state during printer operation. The heating elements 112 are configured to heat or melt the printing material wire feed 118, thereby changing the printing material wire feed 118 from a solid state to a liquid state (e.g., printing material 126) within the inner volume 132 of the ejector 104. The three-dimensional 3D printer 100 and ejector 104 may further include an air or argon shield 114 located near the nozzle 110, and a water coolant source 130 to further enable nozzle and/or ejector 104 temperature regulation. The liquid ejector jet system 100 further includes a level sensor 134 system which is configured to detect the level of molten printing material 126 inside the inner volume 132 of the ejector 104 by directing a detector beam 136 towards a surface of the printing material 126 inside the ejector 104 and reading the reflected detector beam 136 inside the level sensor 134.

The 3D printer 100 may also include a power source, not shown herein, and one or more metallic coils 106 enclosed in a pump heater that are wrapped at least partially around the ejector 104. The power source may be coupled to the coils 106 and configured to provide an electrical current to the coils 106. An increasing magnetic field caused by the coils 106 may cause an electromotive force within the ejector 104, that in turn causes an induced electrical current in the printing material 126. The magnetic field and the induced electrical current in the printing material 126 may create a radially inward force on the printing material 126, known as a Lorenz force. The Lorenz force creates a pressure at an inlet of a nozzle 110 of the ejector 104. The pressure causes the printing material 126 to be jetted through the nozzle 110 in the form of one or more liquid drops 128.

The 3D printer 100 may also include a substrate 144, that is positioned proximate to (e.g., below) the nozzle 110. The substrate 144 may include a heating element, or alternatively be constructed of brass or other materials. In certain examples, the substrate 144 may further include a build plate made of brass which can be coated with nickel to promote the wetting of molten aluminum droplets when they impinge on the build plate. The ejected drops 128 may land on the substrate 144 and solidify to produce a 3D object. The 3D printer 100 may also include a substrate control motor that is configured to move the substrate 144 while the drops 128 are being jetted through the nozzle 110, or during pauses between when the drops 128 are being jetted through the nozzle 110, to cause the 3D object to have the desired shape and size. The substrate control motor may be configured to move the substrate 144 in one dimension (e.g., along an X axis), in two dimensions (e.g., along the X axis and a Y axis), or in three dimensions (e.g., along the X axis, the Y axis, and a Z axis). In another example, the ejector 104 and/or the nozzle 110 may be also or instead be configured to move in one, two, or three dimensions. In other words, the substrate 144 may be moved under a stationary nozzle 110, or the nozzle 110 may be moved above a stationary substrate 144. In yet another example, there may be relative rotation between the nozzle 110 and the substrate 144 around one or two additional axes, such that there is four or five axis position control. In certain examples, both the nozzle 110 and the substrate 144 may move. For example, the substrate 144 may move in X and Y directions, while the nozzle 110 moves up and/or down in a Z direction. In case of a nozzle 110 moving, the nozzle 110 and other printhead assembly components can include a nozzle or printhead motor control, not shown herein.

The 3D printer 100 may also include one or more gas-controlling devices, which may be or include a gas source 138. The gas source 138 may be configured to introduce a gas. The gas may be or include an inert gas, such as helium, neon, argon, krypton, and/or xenon. In another example, the gas may be or include nitrogen. The gas may include less than about 10% oxygen, less than about 5% oxygen, or less than about 1% oxygen. In at least one example, the gas may be introduced via a gas line 142 which includes a gas regulator 140 configured to regulate the flow or flow rate of one or more gases introduced into the three-dimensional 3D printer 100 from the gas source 138. For example, the gas may be introduced at a location that is above the nozzle 110 and/or the heating element 112. This may allow the gas (e.g., argon) to form a shroud/sheath around the nozzle 110, the drops 128, the 3D object, and/or the substrate 144 to reduce/prevent the formation of oxide (e.g., aluminum oxide) in the form of an air shield 114. Controlling the temperature of the gas may also or instead help to control (e.g., minimize) the rate that the oxide formation occurs.

The liquid ejector jet system 100 may also include an enclosure 102 that defines an inner volume (also referred to as an atmosphere). In one example, the enclosure 102 may be hermetically sealed. In another example, the enclosure 102 may not be hermetically sealed. In one example, the ejector 104, the heating elements 112, the power source, the coils, the substrate 144, additional system elements, or a combination thereof may be positioned at least partially within the enclosure 102. In another example, the ejector 104, the heating elements 112, the power source, the coils, the substrate 144, additional system elements, or a combination thereof may be positioned at least partially outside of the enclosure 102. While the liquid ejector jet system 100 shown in FIG. 1 is representative of a typical liquid ejector jet system 100, locations and specific configurations and/or physical relationships of the various features may vary in alternate design examples.

Printing systems as described herein may alternatively include other printing materials such as plastics or other ductile materials that are non-metals. The print material may include a metal, a metallic alloy, or a combination thereof. A non-limiting example of a printing material may include aluminum. Exemplary examples of printing systems of the present disclosure may include an ejector for jetting a print material, including a structure defining an inner cavity, and a nozzle orifice in connection with the inner cavity and configured to eject one or more droplets of liquid print material, wherein the ejector is configured to print a first layer of a three-dimensional printed part from a standoff position relative to the substrate 144 and the ejector is configured to print one or more remaining layers onto the first layer from a z-height position relative to a top surface of the first layer.

FIG. 1 further includes a temperature sensor 146 configured to measure in a location adjacent to the landing spot of an ejected or deposited drop 156. In examples, the temperature sensor 146 is located in a plane between the ejector 104 and the substrate 144. In other examples, a second temperature sensor 154, also located in a plane between the ejector 104 and the substrate 144 can be employed to detect temperature information in a different area as compared to temperature sensor 146. Coupled to the printer 100 or the ejector 104 and the temperature sensors 146, 154 is a temperature analysis module 148 coupled by an electronic circuit 150 connecting the temperature sensors 146, 154 to the ejector 104. The temperature analysis module 148 is configured to analyze temperature information around a deposited drop 156 after a pulse to eject one or more drops 158 of liquid print material has occurred. The temperature analysis module 148 is a part of or is coupled to a computer 152, which can be utilized to generate a temperature result for each of the one or more drops of liquid print material that is ejected in the formation of a three-dimensional part.

The additive manufacturing device, can include a printhead comprising a nozzle having an inner cavity, wherein the nozzle is configured for ejecting droplets of liquid metal drops to form a three-dimensional object, at least one temperature sensor configured to measure the temperature of the liquid metal drop before and after deposition, and a controller in communication with the temperature sensor for estimating laser power based on a pre-drop measurement temperature and adjusting the laser power based on a post-drop measurement temperature, and wherein multiple point sensors are used to measure different locations and angles. In examples, the distance between a drop deposition and the measurement is from about 0.5 to about 10 mm. Furthermore, the temperature measurements are taken within from about 0.5 ms to about 50 ms of deposition of the drop.

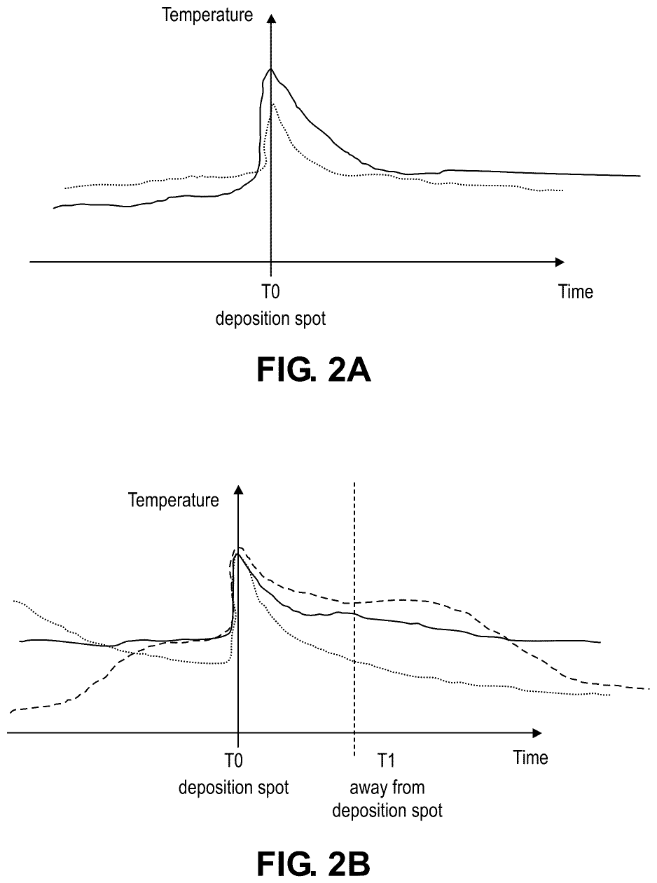

FIGS. 2A and 2B are temperature plots depicting a temperature vs. time curve for a laser direct energy deposition system and a liquid metal jetting system, respectively, in accordance with the present disclosure. In examples, including drop-on-demand additive manufacturing systems or laser directed energy deposition, monitoring the temperature at a deposition spot is conducted. As shown in FIG. 2A for a prior art temperature measurement of a laser DED system, a plot of temperature vs. time is shown, with the deposition spot being indicated (T0) as a point of a peak in temperature over the time plotted. In a conventional metal 3D system, the T0 temperature is the most important control parameter of the deposition process. The solid and dash lines in FIG. 2A illustrate the effect of two different laser power inputs. The temperature at T0 signifies the amount of heat or energy delivered to the building spot. Therefore, for conventional metal 3D system such as laser DED, the temperature right at the building spot is the most meaningful and useful data for the process control. However, in a liquid metal jetting operation monitoring the temperature at a deposition spot or location, indicated by T0 is shown, but in practicality, the T0 deposition spot does not provide much useful information. First, the temperature at the building or deposition spot is dominated by the molten metal, the temperature of which is mostly governed by the molten metal reservoir. It is relatively stable and constant throughout the operation. Secondly, the energy or heat each droplet brings with it during the deposition is not controllable. In addition, because of the small mass of each single droplet, the energy or heat it brings with it during the deposition is very small, far from sufficient to control the building and bonding process. Therefore, in this molten metal drop deposition process, the temperature of the part prior to the deposition can be raised and controlled by means of pre-heating by either localized heating (for example with focused laser) or global heating (for example with convection or IR heating). In liquid metal jetting systems, as represented by FIG. 2B, T1 is an improved location to measure the temperature. Such temperature measurements can provide valuable information about the cooling and co-melting processes that occur during the deposition of each drop in a liquid metal jetting system, allowing for real-time adjustments to be made to laser power, for example, focused spot heating power, in order to achieve optimal part quality and strength. T1 can indicate both a distance from the deposition location, but also a time or temporal position away from the deposition time. In the examples illustrated by FIG. 2B, the solid line represents a globally heated part, while the dashed line represents an unheated part. The dotted line illustrates a locally pre-heated part where the local heating occurred to the left of the dotted line. As shown in FIG. 2B, the temperature measurement at T1 provides much more useful information than the temperature at T0. As a general rule to select the suitable range of T1 for temperature measurements, at T1, the droplet temperature should have dropped significantly from its initial molten temperature, while the temperature has not stabilized towards the asymptotic body temperature of the part.

The example above has illustrated a configuration that considering a given deposition of droplet and selecting a suitable time away from the deposition moment for temperature measurement, this “temporal” separation configuration can be described. In addition, an alternative approach can be taken to take advantage of thermal diffusion. Considering a given time, the heat delivered to a particular spot will diffuse away from the center. At the center, the temperature will not be of much value because the molten metal will again dominate the measurement. However, due to thermal diffusion, at a certain distance away from the center, the temperature will signify the cooling process. This can be referred to as the “spatial” separation configuration. As a general rule, to select the suitable range of distances for temperature measurements, the temperature should have dropped significantly from the molten temperature at the center (yet not too close to the center), while the temperature has not flattened towards the asymptotic body temperature of the part (not too far away from the center). Due to the moving nature of the tool assembly and various arrangements of toolpath and the offsets between the tools, the “temporal” separation configuration and the “spatial” separation configuration are confounded in real world applications.

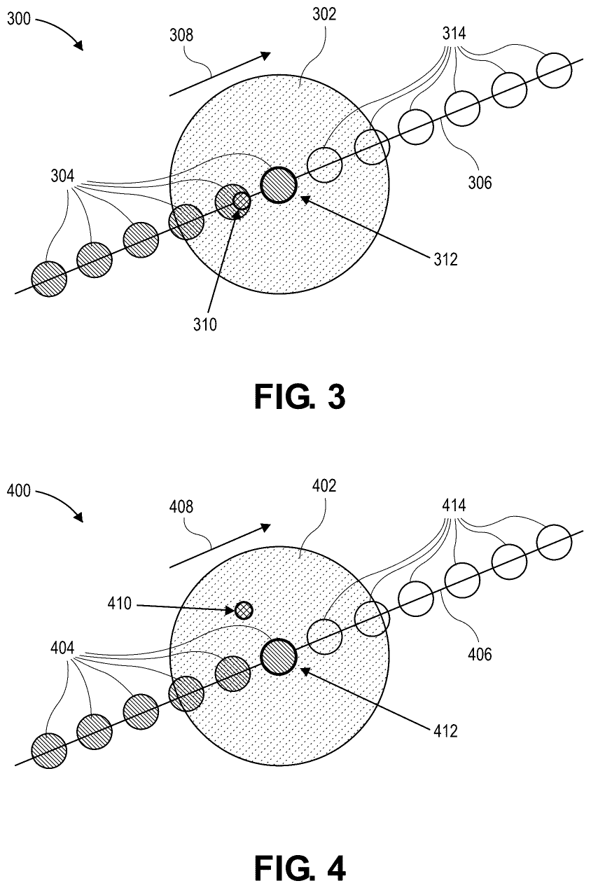

FIG. 3 is a measurement schematic for a liquid metal jetting system, in accordance with the present disclosure. A measurement schematic from a top view of a liquid metal jet deposition area 300 is shown, having a highlighted area of interest 302. In this area of interest 302, there is shown a number of previous deposition locations 304 along a toolpath 306. The previous deposition locations 304 correspond to individual drops of printing material, or liquid metal drops that have been deposited to form or build a three-dimensional object. A temperature measurement location 310 trails a deposition location 312 as the printhead assembly with the nozzle moves along the nozzle travel direction 308 to deposit print material to form a portion of the 3D object. As the nozzle travels along the toolpath 306 in a nozzle travel direction 308, there are also indicated several anticipated subsequent deposition locations 314. These are indicative of future drop locations where printed material drops will be deposited. In the example shown in FIG. 3, the temperature measurement directly follows the liquid metal drop deposition. The temperature measurement moves in-sync with the nozzle, following the toolpath, with a temperature measurement separation from the deposition in both space and time. In alternate examples, the location of the measurement spot could be in a location perpendicular to the toolpath 306, or in a position preceding the drop deposition, or at any angle in between, or on either side of the nozzle or deposition location 312. This configuration is more like the “temporal” separation configuration as previously described, since the delay can be calculated by the offset divided by the tool speed.

FIG. 4 is a measurement schematic for a liquid metal jetting system, in accordance with the present disclosure. A measurement schematic from a top view of a liquid metal jet deposition area 400 is shown, having a highlighted area of interest 402. In this area of interest 402, there is shown a number of previous deposition locations 404 along a toolpath 406. The previous deposition locations 404 correspond to individual drops of printing material, or liquid metal drops that have been deposited to form or build a three-dimensional object. A temperature measurement location 410 is roughly perpendicular to a deposition location 412 along the toolpath 406 as the printhead assembly with the nozzle moves along the nozzle travel direction 408 to deposit print material to form a portion of the 3D object. As the nozzle travels along the toolpath 406 in a nozzle travel direction 408, there are also indicated several anticipated subsequent deposition locations 414. These are indicative of future drop locations where printed material drops will be deposited. In the example shown in FIG. 4, the temperature measurement follows the liquid metal drop deposition at a position substantially perpendicular to the travel of the toolpath 406. The temperature measurement moves in-sync with the nozzle, following the toolpath, with a temperature measurement separation from the deposition in both space and time. In alternate examples, the location of the measurement spot could be in a location in line with and following the toolpath 406, in a position preceding the drop deposition, or at any angle in between, or on either side of the nozzle or deposition location 412. This configuration is more pertinent to the “spatial” separation configuration, since the heat that affects the temperature of the measurement is mostly through the diffusion across the offset distance.

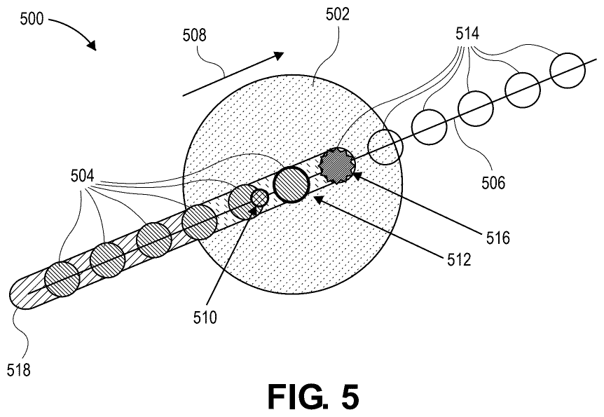

FIG. 5 is a measurement schematic for a liquid metal jetting system, in accordance with the present disclosure. A measurement schematic from a top view of a liquid metal jet deposition area 500 is shown, having a highlighted area of interest 502. In this area of interest 502, there is shown a number of previous deposition locations 504 along a toolpath 506. The previous deposition locations 504 correspond to individual drops of printing material, or liquid metal drops that have been deposited to form or build a three-dimensional object. A temperature measurement location 510 is trailing a deposition location 512 along the toolpath 506 as the printhead assembly with the nozzle moves along the nozzle travel direction 508 to deposit print material to form a portion of the 3D object. As the nozzle travels along the toolpath 506 in a nozzle travel direction 508, there are also indicated several anticipated subsequent deposition locations 514. These are indicative of future drop locations where printed material drops will be deposited. In the example shown in FIG. 5, the temperature measurement follows the liquid metal drop deposition at a position trailing, or directly behind the travel of the toolpath 506. The temperature measurement moves in-sync with the nozzle, following the toolpath, with a temperature measurement separation from the deposition in both space and time. In alternate examples, the location of the measurement spot could be in a location perpendicular to the toolpath 506, in a position preceding the drop deposition, or at any angle in between, or on either side of the nozzle or deposition location 512. Also shown in FIG. 5 is a spot preceding the drop deposition which indicates a laser assisted heating spot location 516, with a heating zone of previously deposited drops 518 of liquid metal trailing behind deposition at the deposition location 512.

The method for controlling temperature in a liquid metal three-dimensional (3D) printing system includes the steps of ejecting a liquid metal drop from a nozzle onto a deposition location to form a portion of a three-dimensional object, measuring a temperature at a measurement spot location offset from the deposition location, comparing the measured temperature with a set point temperature in the deposition location, and adjusting a cooling rate of the liquid metal drop, and wherein the deposition follows a toolpath to form the portion of the three-dimensional object. The method includes wherein the measurement spot location is located within the toolpath of the three-dimensional object being formed, or in alternate examples, where the measurement spot location is located outside of a toolpath of the three-dimensional object being formed. Additional steps in the method for controlling temperature in a liquid metal three-dimensional (3D) printing system can include measuring the temperature before the liquid metal drop is ejected or measuring the temperature after the liquid metal drop is ejected. Further steps can incorporate estimating a quantity of laser power needed to raise a temperature on or near the deposition location based on a difference of the measurement temperature and the set point temperature, and heating with a laser to raise the temperature on or near the deposition location. Adjusting the laser power to maintain a setpoint temperature in the deposition location can also be done. In examples, the temperature measurements use noncontact point sensors, such as IR thermometers, radiation thermometers or pyrometers, that move in-sync with the nozzle. In other examples, the method for controlling temperature in a liquid metal three-dimensional (3D) printing system includes adjusting the measurement spot location in response to changes in a direction of the toolpath, or using multiple point sensors to measure temperature. A time interval between a liquid metal drop deposition and the temperature measurement can be from about 0.5 ms to about 50 ms, or from about 5 ms to about 500 ms depending on the cooling rates of the metal, which can be affected by drop size. The measurement spot location between the deposition spot and a measurement spot can be from around 0.5 to about 10 mm or from about 5 mm to about 50 mm, depending on part material, geometry and thermal states. Additional considerations for the method can include implementing a feedback loop with post-deposition transient temperature as the sensor and focused pre-heat as the actuator for real-time process control and optimization of the cooling rate, resulting in better part quality and strength, or estimating the laser power based on the pre-droplet measurement temperature and confirming the process and adjusting the laser power based on the post-droplet measurement temperature to control and/or adjust the cooling rate and bonding process. In certain examples, point sensors can be attached to the printhead assembly to ensure accurate and consistent measurements as the printhead moves by maintaining small offset distances between the drop landing spot and the temperature sensor measurement spot.

Previous examples of the present disclosure, such as the one shown in FIG. 5, integrate a focused heating source with the printhead assembly to enable laser-assisted pre-heating of an existing part before further LMJ deposition of a liquid print material. This configuration can enable optimal bonding quality and processing efficiency in metal additive manufacturing processes. The integrated design allows for precise control over temperature gradients within the material being processed, which can be beneficial when working with complex geometries or materials exhibiting anisotropic thermal properties.

In these examples, a laser can be used to pre-heat specific areas on a surface of an existing part prior to LMJ deposition. Such a targeted heating approach, or a targeted heat delivery, enables localized heat input and minimizes energy waste by only applying energy where needed. A pyrometer directly following the path of a laser heating device can provide real-time temperature data that may be utilized for controlling the laser power or adjusting processing parameters to achieve optimal bonding conditions during printing or additive manufacturing operations. For example, based on the material properties of either the raw material or the part being produced, power or other process parameters can be adjusted during printing.

The integrated printhead assembly design offers several advantages, including reduced system complexity compared to separate tools and improved thermal management due to minimized heat transfer losses between components. Additionally, this configuration enables precise control over toolpath planning by allowing adjustments in real-time based on temperature data from the pyrometer sensor. The laser-assisted pre-heating approach may be particularly useful for processing materials with high melting points or those requiring specific bonding conditions. In examples. the printhead assembly can be configured such that the laser, pyrometer, and the deposition head are either integrated into one assembly, separated from one another, or any combination thereof. In some implementations, a galvo scanner drives the laser beam to scan across the build surface while maintaining precise control over spot size and power levels. This allows for flexible toolpath planning and enables efficient printing operations.

The focused energy source in the context of the present disclosure refers to a device capable of delivering targeted heat input for pre-heating purposes during Liquid Metal Jetting (LMJ) 3D printing processes. This can be implemented using various technologies such as lasers or electron beams, which are configured to concentrate thermal energy onto specific areas on a surface of an existing part before deposition of new material. The wavelength range and power level of this focused energy source may vary depending on the application requirements, with a high-powered CO₂ laser being suitable for heating some metal alloys. Blue laser, for example, would be more efficient for copper and its alloys.

In operation, the focused energy source is used in conjunction with printing systems to pre-heat specific areas on the existing part's surface before deposition of new material. This process enables precise control over temperature and heat input at these locations to achieve optimal bonding conditions between old and new materials. The timing of laser pulses or other heating sources can also affect thermal diffusion rates within the material being processed or printed.

In examples, the focused energy source is can raise the surface temperature of an existing or in-progress part by about 200° C. to about 1000° C. depending on specific application requirements, print configuration, or materials. This raised temperature should be below the desired bonding temperature and interface temperature upon impact of liquid metal droplet, ensuring optimal bond strength between an existing part and newly printed materials. The distance between a heated spot creation using laser or other focused energy source and deposition can affect heat transfer efficiency and localized thermal gradients around deposited droplets.

In examples, multiple lasers may be used simultaneously to pre-heat different areas on same build surface in a single pass. This type of arrangement can offer increased processing speed and flexibility by enabling simultaneous heating of multiple spots or regions within a single toolpath. Other design considerations or factors can include beam overlap, heat distribution, and thermal management when using multi-beam configurations.

In examples, the LMJ or other additive manufacturing toolpath can be characterized by a brief window, or lead time, of from about 0.5 ms to about 50 ms, where simultaneous or near-simultaneous heating of both sources (the existing part and the newly printed material) occurs, allowing for optimal thermal diffusion rates within the material being processed. This synchronized approach ensures that localized temperature gradients are maintained at interfaces between old and new materials. It is desirable to have this lead time to be minimized to improve thermal efficiency. Hardware constraints set the limits in most configurations. A lead time of less than 5 ms is a common compromise.

The physical distance between a targeted external heat source delivery and drop deposition can also impact bonding quality within a part. This distance can be from about 0.5 mm to about 30 mm. A shorter lead time or distance may result in additional focused heating, while longer distances allow for broader thermal diffusion within the material. The flexibility of a toolpath can be further enhanced by its ability to accommodate various build surface geometries without compromising processing efficiency. It is desirable to have this distance to be minimized to improve thermal efficiency. Hardware constraints set the limits in most configurations. A distance of less than 10 mm is a common compromise.

The timing of laser pulses or energy delivered by other heating sources can affect temperature diffusion rates within the material being processed, influencing heat-affected zones (HAZs) around the deposition site. By synchronizing drop deposition with targeted external heating, precise control over bonding conditions may be achieved during simultaneous processing.

In examples, the range may be established through calibration of drop deposition toolpaths in conjunction with laser/focused heating parameters. For instance, a lead distance within 0.5 mm to 2 mm may provide optimal bonding quality for parts requiring high precision or complex geometries, while longer distances (such as from 4 mm to about 10mm) might be more suitable for larger build volumes or simpler part designs where thermal diffusion is less useful.

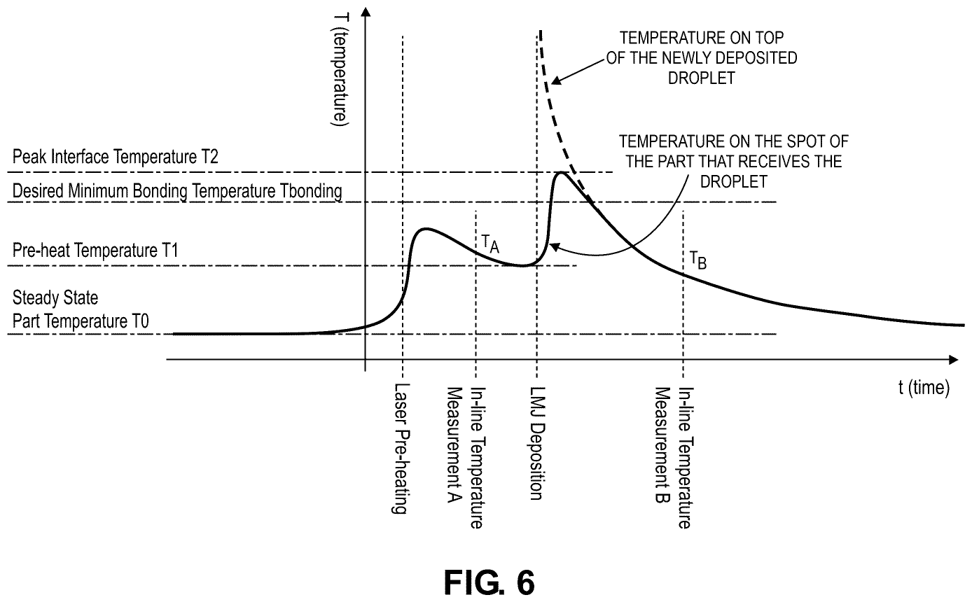

FIG. 6 is a plot depicting the evolution of an ideal spot as it goes through the temperature control method, in accordance with the present disclosure. The graph is depicted with a y-axis of temperature (T) and an x-axis of time (t). Upon focusing on the spot of interest, where the spot can refer to a spot on the part being fabricated or printed that will receive the droplet. The solid curve of FIG. 6 illustrates its temperature evolution as it goes through the temperature control process described herein. Prior to a laser pre-heat, a spot temperature, T0, will be the steady state temperature of the part, T0. During laser pre-heating, the spot temperature will be raised and increase. After, or post-laser-pre-heating, the spot temperature will start to drop, which is a transient process. At the x-axis point labeled as Inline temperature measurement A, during this post laser pre-heating transient period, a temperature measurement T_{A}, will provide an indicator for the target pre-heat temperature T1. In some examples, this inline temperature measurement location can also coincide with the pre-heating location (simultaneous pre-heating and temperature monitoring). Pre-heat temperature T1 is the temperature of the spot on the part just before the droplet is deposited. Next on the time (t) axis is an LMJ deposition indicator, where droplet deposition occurs and a molten metal drop is deposited on the spot. The molten metal will come in at a molten temperature, the highest temperature of the system, much higher than the part temperature, or the other temperatures noted herein. During a post-droplet deposition transient period, the molten droplet carries a large amount of heat and is a pulse heat source for the “spot”. Now, the temperature of the droplet will decrease, as it gives away or loses its heat to the spot and the rest of the part. The temperature of the spot, now at the interface between the part and the newly deposited droplet, will first rise sharply due to the quick injection of heat from the droplet, and then decreases as the heat is dissipated through the body of the part. During this transient, a peak interface temperature T2, will be reached. For desired bonding performance, this T2 should be greater or equal a lower threshold temperature of T_{bonding}. The temperature at the interface cannot be directly measured. However, the transient temperature on top of the droplet can provide an indicator of this bonding process. Another inline temperature measurement T_{B} can be carried out. As the spot moves far away from the printing zone, its temperature will decrease towards T0 again. Either or both TA and TB can be good indicators for T1 and T2. They can be used for control of the laser pre-heating power.

For best mechanical bonding performance, the pre-heating T1 and T_{bonding} can be selected according to the properties of the materials, more specifically, according to its microscopic grain structure formation during the cooling and solidification process. This could be very complicated, and the optimal conditions can be derived from a series of trials and experimentation. There are two distinct preferred embodiments suitable for their respective class of materials. For materials that can solidify easily and orderly from a molten state, a melt-pool is a desirable state for the pre-heating function. For example, many castable materials/alloys/metals such as Al4008, the establishment of a melt-pool through pre-heating (T1>melting temperature, or T1>liquidous temperature) can promote complete fusion of the existing part and the incoming droplet. In this pre-heat melt pool example, both T1 and T_{bonding} can be greater than the melting point of the metal (or the liquidous point of the alloy).

For non-castable materials/alloys, structural defects can be formed during slow solidification process, such as the cooling process of casting. For example, Al6061 is a non-castable alloy. To print materials such as Al6061 in a liquid metal jetting process, a different pre-heating example is required. T1 is carefully controlled to be below its liquidous temperature. T1 can be greater than its solidus temperature for some examples. In this example, no significant melt-pool is formed after pre-heat and before the droplet deposition. This can be denoted as the pre-heat no melt pool example. When the molten droplet deposits on top of the pre-heat spot, the heat within the molten droplet will momentarily raise the temperature of the region around the pre-heat spot to a level above T_{bonding}. In some cases, T_{bonding} is lower than the melting point of the material and there is no melt-pool around the pre-heat spot on the existing part. In another example, T_{bonding} can be greater than the melting point of the metal (or liquidus point of the alloy). In these situations, a small melt pool is formed near the interface (right under the droplet). Due to the fast cooling following the droplet deposition, this melt pool is quenched quickly before any harmful micro grain structure is formed. With good control of pre-heat T1, even non-castable materials such as Al6061 can be printed with part strength rival their wrought counterpart.

In addition to bonding performance, the 3D printing must maintain good geometrical accuracy. Pre-heating to a temperature below the melting point of the existing part will introduce minimal deformation of the part before the deposition of the new material. Therefore, the pre-heat no melt pool example is desired for portions of the part that are dimensionally critical. Even for material that prefers the pre-heat melt pool example for bonding (for example for the bulk of the body or the infill region of the part), pre-heat no melt pool conditions can be selectively applied to some portions of the part that requires better geometrical accuracy, such as the sharp features, outer surfaces and part perimeters.

In general, pre-heating to a temperature slightly below the melting point of the existing part is suitable for most situations. For alloys, a temperature above its solidus temperature but below its liquidus temperature is commonly used for T1. For T_{bonding}, a value that is slightly above the melting point (or liquidus temperature) is also useful for most cases, because the fast cooling after the initial temperature rise upon liquid droplet deposition can prevent the formation of large harmful grain structure within the metal/alloy.

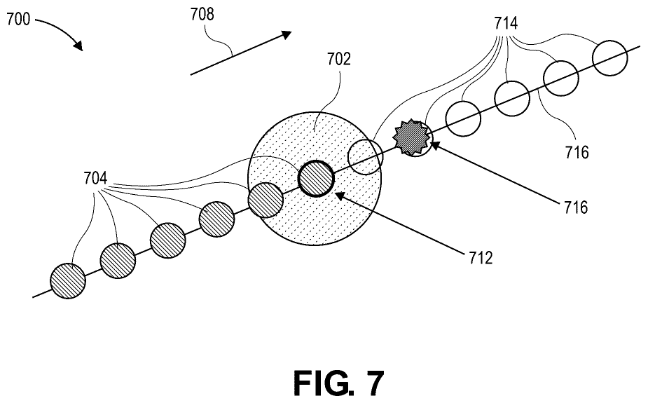

FIG. 7 is a measurement schematic for a liquid metal jetting system, in accordance with the present disclosure. A measurement schematic from a top view of a liquid metal jet deposition area 700 is shown, having a highlighted area of interest 702. In this area of interest 702, there is shown a number of previous deposition locations 704 along a toolpath 706. The previous deposition locations 704 correspond to individual drops of printing material, or liquid metal drops that have been deposited to form or build a three-dimensional object. A temperature measurement location is not shown in relation to a deposition location 712 that moves along the toolpath 706 as the printhead assembly with the nozzle moves along the nozzle travel direction 708 to deposit print material to form a portion of the 3D object. In this example, laser scanning and droplet deposition toolpaths are independent. For example, the laser can be driven by a galvo scanner or a 2 dimensional (2D) slide, while the LMJ drop deposition can be driven by an independent 2 dimensional (2D) slide. While the part x-y position is fixed, the LMJ head and laser can be moving and/or scanning the build surface of the part. therefore, the distance and the orientation between the laser spot and the LMJ deposition spot can be independently adjusted. For toolpaths moving in different directions, the laser spot position can be independently adjusted to align with the toolpath. As the nozzle travels along the toolpath 706 in a nozzle travel direction 708, there are also indicated several anticipated subsequent deposition locations 714. These are indicative of future drop locations where printed material drops will be deposited. In the example shown in FIG. 7, the temperature measurement, not indicated herein, can follow the liquid metal drop deposition at a position trailing, or directly behind the travel of the toolpath 706. The temperature measurement can move in-sync with the nozzle, following the toolpath, with a temperature measurement separation from the deposition in both space and time. In alternate examples, the location of the measurement spot could be in a location perpendicular to the toolpath 706, in a position preceding the drop deposition, or at any angle in between, or on either side of the nozzle or deposition location 712. Also shown in FIG. 7 is a spot preceding the drop deposition which indicates a laser assisted heating spot location 716, which implies a heating zone of anticipated subsequent deposition locations preceding the current deposition location 712.

This arrangement, having separate tools for laser heating and LMJ deposition, allows independent control over each component, enabling flexibility in toolpath planning to accommodate complex geometries or varying material properties. Furthermore, this example can offer flexibility in terms of system design considerations such as beam overlap, heat distribution, and thermal management when using multiple lasers or different types of focused energy sources. The separate tools configuration also allows for easier maintenance and replacement of individual components if needed, reducing downtime during processing cycles.

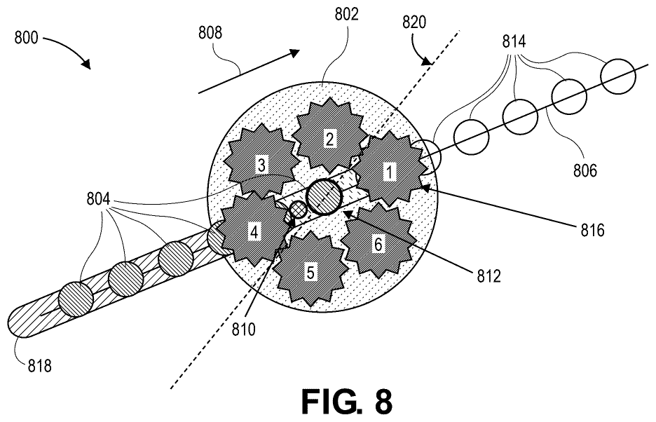

FIG. 8 is a measurement schematic for a liquid metal jetting system, in accordance with the present disclosure. A measurement schematic from a top view of a liquid metal jet deposition area 800 is shown, having a highlighted area of interest 802. In this area of interest 802, there is shown a number of previous deposition locations 804 along a toolpath 806. The previous deposition locations 804 correspond to individual drops of printing material, or liquid metal drops that have been deposited to form or build a three-dimensional object. A temperature measurement location 810, which is trailing a deposition location 812 along the toolpath 806 as the printhead assembly with the nozzle moves along the nozzle travel direction 808 to deposit print material to form a portion of the 3D object. As the nozzle travels along the toolpath 806 in a nozzle travel direction 808, there are also indicated several anticipated subsequent deposition locations 814. These are indicative of future drop locations where printed material drops will be deposited. In the example shown in FIG. 8, the temperature measurement follows the liquid metal drop deposition at a position trailing, or directly behind the travel of the toolpath 806. The temperature measurement moves in-sync with the nozzle, following the toolpath, with a temperature measurement separation from the deposition in both space and time. In alternate examples, the location of the measurement spot could be in a location perpendicular to the toolpath 806, in a position preceding the drop deposition, or at any angle in between, or on either side of the nozzle or deposition location 812. Also shown in FIG. 8 is a spot preceding the drop deposition which indicates a laser assisted heating spot location 816, with a heating zone of previously deposited drops 818 of liquid metal trailing behind deposition at the deposition location 812. In this example, the laser assisted heating spot location 816 includes multiple focused heating sources, in this example, six lasers, labeled as 1, 2, 3, 4, 5, and 6, located upon the same deposition tool assembly as the LMJ deposition ejector or print head. Multiple lasers are available for use and are mounted on the printhead assembly. One or more lasers can be selectively turned on depending on the tool path direction, or all can be activated. As an example, laser 1 and laser 4 are on for the illustrated toolpath 806. As a further variation, pre-heating in this example can be applied with (laser 1 and laser 4) or without post-heating (laser 1 only). In an alternate example, for the dash line toolpath 820, laser 1, laser 2, laser 4, and laser 5 can be turned on, with variable powers. This configuration is particularly useful for toolpaths running in various directions. This configuration may also be useful when processing materials with varying thermal properties that require specific temperature profiles for optimal bonding quality. The selective activation of individual laser beams can be achieved through a control system that monitors the orientation of a part and adjusts heat input accordingly. This approach enables precise temperature gradients to be established across the build surface, which in turn facilitates optimal bonding quality between new material deposition and existing parts surfaces. Furthermore, this configuration allows for real-time adjustments based on process parameters such as thermal conductivity, viscosity, or flow rate of molten metal during processing.

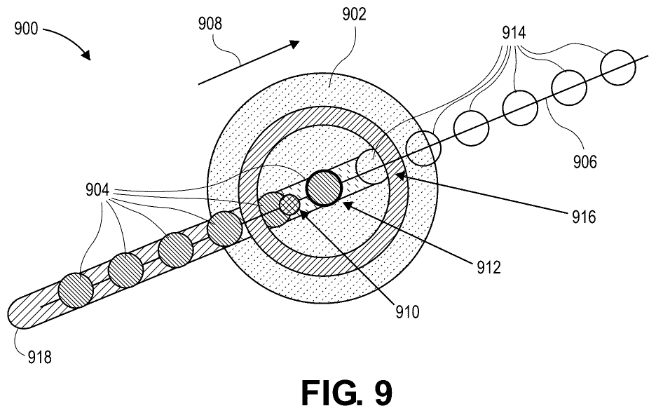

FIG. 9 is a measurement schematic for a liquid metal jetting system, in accordance with the present disclosure. A measurement schematic from a top view of a liquid metal jet deposition area 900 is shown, having a highlighted area of interest 902. In this area of interest 902, there is shown a number of previous deposition locations 904 along a toolpath 906. The previous deposition locations 904 correspond to individual drops of printing material, or liquid metal drops that have been deposited to form or build a three-dimensional object. A temperature measurement location 910 is trailing a deposition location 912 along the toolpath 906 as the printhead assembly with the nozzle moves along the nozzle travel direction 908 to deposit print material to form a portion of the 3D object. As the nozzle travels along the toolpath 906 in a nozzle travel direction 908, there are also indicated several anticipated subsequent deposition locations 914. These are indicative of future drop locations where printed material drops will be deposited. In the example shown in FIG. 9, the temperature measurement follows the liquid metal drop deposition at a position trailing, or directly behind the travel of the toolpath 906. The temperature measurement moves in-sync with the nozzle, following the toolpath, with a temperature measurement separation from the deposition in both space and time. In alternate examples, the location of the measurement spot could be in a location perpendicular to the toolpath 906, in a position preceding the drop deposition, or at any angle in between, or on either side of the nozzle or deposition location 912. Also shown in FIG. 9 is a spot preceding the drop deposition which indicates a ring-shaped laser assisted heating spot location 916, with a heating zone of previously deposited drops 918 of liquid metal trailing behind deposition at the deposition location 912. The ring-shaped 916 focused heating profile from a radiation source and drop deposition in this example are on the same tool assembly or are in fixed relative position with respect to the part surface. A ring shaped, symmetric configuration works for all toolpath directions. The ring-shaped heating zone can be constructed from a single laser or multiple segments of arc shaped laser spots. The pyrometer measurement can be taken either inside, outside or on the ring. This example offers symmetrical heat distribution, independent of toolpath direction.

In examples of the present disclosure, methods for preheating in a three-dimensional (3D) printing system, such as the LMJ printing system described, can include providing a three-dimensional part comprised of a printing material with at least one existing surface, directing focused energy from an external source to the existing surface of the part, thereby raising a temperature of the existing surface, and depositing additional print material onto a preheated portion of the existing surface at a deposition location, wherein depositing additional print material follows a toolpath. Exemplary print materials can include metal, for example aluminum or aluminum alloy, liquid metal, plastics, polymers, or other printing materials. When printing an additional print material, the print material can be liquid metal, such as the same liquid metal, or in examples, a different liquid metal, alloy or other print material. Methods of the present disclosure can further include adjusting a distance between the focused energy source and the deposition location to within a range of 0.5 mm to 10 mm, wherein the distance is adjusted based on the print material properties or dimensions. In examples, the external source is selected from laser radiation, electron beam, or other forms of electromagnetic radiation. Methods of the present disclosure can further include measuring a temperature with a pyrometer at a measurement spot location offset from the deposition location and controlling a power level of the focused energy based on temperature data obtained by the pyrometer and adjusting the focused energy accordingly, or in alternate examples, re-aligning a focal point of the focused energy with respect to toolpath changes during printing. In still other examples, these multiple focused energy sources are used for preheating different areas on a single part surface.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A method for preheating in a three-dimensional (3D) printing system, comprising:
providing a three-dimensional part comprised of a printing material with at least one existing surface;
directing focused energy from an external source to the existing surface of the part, thereby raising a temperature of the existing surface; and
depositing additional print material onto a preheated portion of the existing surface at a deposition location, wherein depositing additional print material follows a toolpath.

2. The method for preheating in a three-dimensional (3D) printing system of claim 1, wherein the print material is metal.

3. The method for preheating in a three-dimensional (3D) printing system of claim 1, wherein the additional print material is liquid metal.

4. The method for preheating in a three-dimensional (3D) printing system of claim 1, wherein the temperature of the existing surface is raised by more than 100° C.

5. The method for preheating in a three-dimensional (3D) printing system of claim 1, a lead time of preheating prior to deposition of the additional print material is within a range of 0.5 ms to 50 ms.

6. The method for preheating in a three-dimensional (3D) printing system of claim 1, further comprising adjusting a distance between the focused energy source and the deposition location to within a range of 0.5 mm to 10 mm.

7. The method for preheating in a three-dimensional (3D) printing system of claim 1, wherein the external source is selected from laser radiation, electron beam, or other forms of electromagnetic radiation.

8. The method for preheating in a three-dimensional (3D) printing system of claim 1, further comprising:
measuring a temperature with a pyrometer at a measurement spot location offset from the deposition location; and
controlling a power level of the focused energy based on temperature data obtained by the pyrometer and adjusting the focused energy accordingly.

9. The method for preheating in a three-dimensional (3D) printing system of claim 1, further comprising re-aligning a focal point of the focused energy with respect to toolpath changes during printing.

10. The method for preheating in a three-dimensional (3D) printing system of claim 1, wherein multiple focused energy sources are used for preheating different areas on a single part surface.

11. A system for preheating in three-dimensional (3D) metal jetting (LMJ) additive manufacturing process, comprising:
a focused energy source configured to deliver targeted heat to a surface of an existing part;
an deposition tool assembly; and
control logic programmed to coordinate the delivery of the focused energy with movement of the deposition tool assembly.

12. The system for preheating in three-dimensional (3D) metal jetting (LMJ) additive manufacturing process of claim 11, wherein the focused energy source is mounted onto the deposition tool assembly.

13. The system for preheating in three-dimensional (3D) metal jetting (LMJ) additive manufacturing process of claim 11, further comprising a temperature measurement device.

14. The system for preheating in three-dimensional (3D) metal jetting (LMJ) additive manufacturing process of claim 13, wherein the temperature measurement device is mounted onto the deposition tool assembly.

15. The system for preheating in three-dimensional (3D) metal jetting (LMJ) additive manufacturing process of claim 11, further comprising a laser as the focused energy source.

16. The system for preheating in three-dimensional (3D) metal jetting (LMJ) additive manufacturing process of claim 11, wherein the control logic is programmed to adjust timing and position of the targeted heat delivery based on toolpath direction changes during printing.

17. The system for preheating in three-dimensional (3D) metal jetting (LMJ) additive manufacturing process of claim 11, wherein the focused energy source comprises multiple lasers for simultaneous preheating of different areas on the surface of the existing part.

18. The system for preheating in three-dimensional (3D) metal jetting (LMJ) additive manufacturing process of claim 17, wherein each laser is independently adjustable and may be turned off or adjusted individually.

19. The system for preheating in three-dimensional (3D) metal jetting (LMJ) additive manufacturing process of claim 11, wherein the control logic is programmed to adjust laser power and/or pulse duration based on material properties of the existing part.

20. The system according to claim 11, wherein the focused energy source comprises a ring-shaped heating zone.
